(19) United States
(12) Patent Application Publication
(10) Pub. No.: US 2026/0161264 A1
(43) Pub. Date: Jun. 11, 2026

(54) ZMC eLearning Multiplication Calculator Without Tables Using Neighbor Digits Addition

(71) Applicant: Omar Ali Zargelin, Redford, MI (US)

(72) Inventor: Omar Ali Zargelin, Redford, MI (US)

(21) Appl. No.: 19/006,869

(22) Filed: Dec. 31, 2024

(51) Int. Cl. G06F 3/0482; G06F 7/523; G06T 11/26

(52) U.S. Cl. CPC G06F 3/0482; G06F 7/523; G06T 11/26

(57) ABSTRACT

The ZMC eLearning Multiplication Calculator is an innovative educational tool designed to teach and perform multiplication without traditional multiplication tables. Utilizing the RealFlow Multiplier Algorithm (RFMA) and Zargelin Mathematical Chain (ZMC), it enables users to solve multiplication problems through simple addition of neighboring digits. Featuring dynamic interfaces, the calculator provides a visual, interactive, and step-by-step method for enhanced clarity and engagement. It operates in real time and supports calculations of any size, working to infinity. By integrating customizable display options, dynamic chain link formation, and interactive learning modes, the calculator is suitable for learners of all ages and skill levels. This tool is ideal for educational environments, training programs, and digital applications, optimizing both the learning process and computational accuracy while fostering a deeper understanding of arithmetic principles.

### FIELD OF TECHNOLOGY

The present invention relates to the field of educational tools, particularly a Multiplication Learning Calculator that implements the RealFlow Multiplier Algorithm (RFMA) based on the Zargelin Mathematical Chain (ZMC). This calculator presents distinct user interfaces, allowing users to learn and perform multiplication through simple addition of neighboring digits without the need for traditional multiplication tables. The system provides a visual, step-by-step method for understanding and solving multiplication problems, integrating both educational and computational elements. It is particularly useful in educational environments, training programs, and digital calculators for learners of various ages and proficiency levels, optimizing both learning and accuracy in multiplication tasks.

### BACKGROUND OF THE INVENTION

Traditional multiplication methods rely on memorizing multiplication tables, which is a particularly challenging process for many learners who struggle with recall. This approach, based on rote memorization, not only hinders a deeper understanding of the concept of multiplication but also causes difficulties when advancing to more complex levels of mathematics. Moreover, this method consumes significant time and effort from both teachers and students, reducing the overall efficiency of the educational process.

While digital calculators offer solutions for multiplication, most of them continue to reinforce the memorization of multiplication tables or provide answers without explaining the process. These tools fail to engage learners in understanding how numbers interact during multiplication, especially when dealing with carry-over scenarios. Moreover, they have contributed to the inactivity of human brain cells, as they do not encourage thinking or analysis. Additionally, these calculators sometimes do not provide exact results but rather approximate answers, and most standard electronic calculators are limited to performing multiplication for a specific range of numbers. Nevertheless, having and using them remains an essential necessity for users.

There are many methods and concepts for performing multiplication mentally, such as using numbers close to 10 and its multiples in quick and efficient ways as an alternative to traditional methods. However, these methods are not general rules, as they can be applied to some numbers but not to others, which still necessitates memorizing multiplication tables. Additionally, these methods are numerous and diverse, requiring learners to memorize them as well.

The need for an innovative educational approach that focuses on simplifying calculations and quickly finding the correct solution with high accuracy in real-time has become imperative. Such a method would enable students to perform calculations quickly and efficiently without the need for rote memorization of multiplication tables or a deep understanding of complex mechanisms. Emphasizing speed and accuracy in real-time provides a practical learning experience, giving learners confidence in handling numbers instantly and effectively in various contexts.

The Zargelin Mathematical Chain for Multiplication is an innovative and efficient method for performing all multiplication operations. It relies on simple and quick steps that make it easy to work with numbers without the need to memorize traditional multiplication tables. Thanks to its versatility, this method is applicable to all types of numbers, whether small or large, making it a practical and distinctive alternative to traditional methods. It helps simplify mathematical concepts and enhance a deeper understanding of the calculation process.

The Zargelin Mathematical Chain represents an innovative methodology designed to address the challenges associated with traditional multiplication teaching methods. This chain provides a simple and effective alternative for performing all multiplication operations with ease, without requiring the memorization of multiplication tables. It is based on systematic and straightforward steps that simplify understanding numbers and mathematical operations, making it applicable to any numbers, whether small or large. One of the key advantages of this chain is that it not only facilitates mathematical operations but can also be applied to numbers infinitely, with high accuracy and in real-time. This makes it a unique and highly effective tool, well-suited for both learning and practical applications.

The mathematical foundation of the RealFlow Multiplier Algorithm (RFMA), submitted as an independent patent application in the United States under patent Ser. No. 18/919,139, is the Zargelin Mathematical Chain. This innovative chain forms the core methodology behind the educational calculator. Its steps have been meticulously integrated into the calculator's design and programming, resulting in a powerful educational tool that operates with precision and speed in real-time.

### SUMMARY OF THE INVENTION

The educational calculator offers an interactive experience that simplifies the process of learning mathematics, making it both enjoyable and effective. With the robust foundation of the Zargelin Chain, the calculator can handle numbers of unlimited size, enhancing its efficiency as an innovative educational tool. It provides significant value in improving students' arithmetic skills and fostering their mathematical thinking, making it an essential resource for modern education.

The present invention is an updated version of the RealFlow Multiplier Algorithm (RFMA), previously patented as the core methodology for simplifying multiplication using addition of neighboring digits. Building upon that foundation, this patent introduces a novel Multiplication eLearning Calculator that eliminates the need for memorization of multiplication tables. The step-by-step approach breaks down the multiplication process into smaller, manageable steps using chain links to represent digits from the multiplicand and multiplier, enhancing user understanding.

The calculator, based on the Zargelin Mathematical Chain (ZMC), processes each digit pair from left to right. Each chain link is handled individually, reducing cognitive load and making the operations easy to follow. As in earlier patents, this method also supports intuitive handling of carry operations, ensuring clarity for the user.

The present version builds upon the original ZMC by incorporating enhanced visualization and interaction through Layout, which is structured to optimize user experience. It introduces sub-versions that handle carry operations differently: most of Sub-ZMC include some versions like: Goodbye Multiplication Table x, Direct No Carry, Indirect No Carry, Carry+, and ZMC x where x is multiplicand like 11.

This calculator not only computes the final result but also visually displays the entire process, helping users trace each calculation step. It is designed for learners of all ages, particularly those looking to strengthen their understanding of multiplication without relying on memorization. This invention offers an updated interface compared to previous patents, particularly in how it handles the carry options and visual feedback.

Furthermore, the invention includes features for adjusting the difficulty level and providing exercises for learners to practice at different versions. The calculator supports multiple languages and can be used in various educational settings, making it a versatile tool for teachers and students alike. By providing immediate visual feedback and step-by-step guidance, the invention helps build confidence in multiplication without relying on memorization, making the learning experience more engaging and effective.

Table 1 comprehensively details the ZMC's part-algorithms, each specifically designed for particular multiplicand values. This structured approach enables users to easily navigate the ZMC system and quickly identify the appropriate part-algorithm for their multiplication tasks. The inherent symmetry in the ZMC system is particularly noteworthy, as pairs like ZMC-11 with ZMC-6, ZMC-12 with ZMC-7, ZMC-10 with ZMC-5, ZMC-9 with ZMC-4, and ZMC-8 with ZMC-3 illustrate a consistent relationship between higher and lower multiplicands. This symmetry simplifies the learning process by emphasizing shared principles between paired algorithms. For instance, while ZMC-11 uses “add” as its fundamental rule, ZMC-6 applies a similar rule of “add to half.” Similarly, ZMC-12 employs “double and add,” while ZMC-7 uses “double and add to half.” Recognizing these connections allows users to intuitively grasp the ZMC system, improving their efficiency and clarity when performing multiplication operations. This organized framework demonstrates the ZMC system's ability to provide a seamless and systematic method for multiplication without reliance on traditional multiplication tables, simplifying the multiplication process.

TABLE l

| * | Multiplier Sequence (a: bᵢ: c) | Rule | m |
|---|---|---|---|
| 12 | a: bᵢ + 2bᵢ₋₁: 2c | Double & add | 1 |
| 7 | $int ( \frac{a}{2} ) : int ( \frac{{b}_{i}}{2} ) + \{ \begin{matrix}2 {b}_{i - 1} & if {b}_{i - 1} is E \\ 2 {b}_{i - 1} + 5 & else\end{matrix} : \{ \begin{matrix}2 c & if c is E \\ 2 c + 5 & else\end{matrix}$ | Double & add with the half | 2 |
| 11 | a: bᵢ + 2bᵢ₋₁: c | Add | 3 |
| 6 | $int ( \frac{a}{2} ) : int ( \frac{{b}_{i}}{2} ) + \{ \begin{matrix}{b}_{i - 1} & if {b}_{i - 1} is E \\ {b}_{i - 1} + 5 & else\end{matrix} : \{ \begin{matrix}c & if c is E \\ c + 5 & else\end{matrix}$ | Add with the half | 4 |
| 10 | a: bᵢ: c | Zero & add | 5 |
| 5 | $int ( \frac{a}{2} ) : int ( \frac{{b}_{i}}{2} ) + \{ \begin{matrix}0 & if {b}_{i - 1} is E \\ 5 & else\end{matrix} : \{ \begin{matrix}0 & if c is E \\ 5 & else\end{matrix}$ | Zero & add with the half | 6 |
| 9 | a − 1: bᵢ + 9 − bᵢ₋₁: 10 − c | Complement | 7 |
| | | & add | |
| 4 | $int ( \frac{a}{2} ) - 1 : int ( \frac{{b}_{i}}{2} ) + \{ \begin{matrix}9 - {b}_{i - 1} & if {b}_{i - 1} is E \\ 9 - {b}_{i - 1} + 5 & else\end{matrix} : \{ \begin{matrix}10 - c & if c is E \\ 10 - c + 5 & else\end{matrix}$ | complement & add with the half | 8 |
| 8 | a − 2 : bᵢ + 2(9 − bᵢ₋₁) : 2(10 − c) | Double the | 9 |
| | | Complement and | |
| | | Add | |
| 3 | $int ( \frac{a}{2} ) - 2 : int ( \frac{{b}_{i}}{2} ) + \{ \begin{matrix}2 ( 9 - {b}_{i - 1} ) & if {b}_{i - 1} is E \\ 2 ( 9 - {b}_{i - 1} ) + 5 & else\end{matrix} : \{ \begin{matrix}2 ( 10 - c ) & if c is E \\ 2 ( 10 - c ) + 5 & else\end{matrix}$ | Double complement & | 10 |
| | | add with the half | |

The present invention introduces a Multiplication Learning Calculator using the RealFlow Multiplier Algorithm (RFMA), based on the Zargelin Mathematical Chain (ZMC). This invention, particularly featuring Layout 1, simplifies multiplication by using addition of neighboring digits instead of traditional multiplication tables. The system offers 4-versions to handle different carry behaviors.

### BRIEF DESCRIPTION OF THE DRAWINGS

FIG. 1 shows a schematic representation of an embodiment of the invention illustrating the structure of chain links in the Zargelin Mathematical Chain (ZMC) method. Each chain link connects digits of the multiplier to perform specific calculations;

FIG. 2 shows a schematic representation of the Zargelin Mathematical Chain (ZMC) system, outlining multiple sub-calculators and mathematical tools used in the invention. The figure displays various ZMC methods and associated components organized within a structured layout;

FIG. 3 illustrates the process flowchart for performing multiplication using the Zargelin Mathematical Chain (ZMC) method, detailing each step from selecting the multiplicand to obtaining the final result;

FIG. 4A illustrates an example of overlapping chain links in the Zargelin Mathematical Chain (ZMC) method:

FIG. 4B illustrates the same example of chain links, shown in a separated configuration in the Zargelin Mathematical Chain (ZMC) method;

FIG. 5 illustrates the general user interface layout of the Zargelin Mathematical Chain (ZMC) calculator, showcasing various components and fields that facilitate user interaction and calculation processes;

FIG. 6 depicts the interface image of the ZMC 11 eLearning Calculator. It highlights the “Quick and Easy Multiplication Method, No Tables Required” feature, which allows users to multiply numbers by 11 step-by-step without needing the traditional multiplication table. The interface includes an input box for entering digits, a reset button, language selection, and visual instructions on chain links;

FIG. 6A shows the “Goodbye 11 Table” mode of the ZMC 11 eLearning Calculator. This mode focuses on simple one-digit multiplication by 11, demonstrating the result visually through chain links. It includes an input field, reset button, and diagrammatic explanation of the process.

FIG. 6B showcases the “Direct No Carry (Digits <5)” mode of the ZMC 11 eLearning Calculator. This mode simplifies multiplication by 11 for numbers where each digit is less than 5, ensuring no carry operations are needed. The interface includes an input field, result display, chain link calculations, and a visual explanation of the chain link process.

FIG. 6C displays the “Indirect No Carry (Sum <10)” mode of the ZMC 11 eLearning Calculator. This mode enables multiplication by 11 while keeping the sum of digits in each chain link under 10 to avoid carry operations. It includes an input field, final result display, chain link calculations, and a visual explanation of the process.

FIG. 6D illustrates the “Carry +” mode of the ZMC 11 eLearning Calculator, which focuses on handling carry operations during multiplication by 11. The interface includes an input field, dynamic result display, detailed chain link calculations highlighting carries, and a visual diagram explaining the chain link and carry process.

FIG. 6E demonstrates the ZMC 11 mode of the ZMC 11 eLearning Calculator, which allows multiplication by 11 for numbers up to 15 digits, including handling carry operations. The interface includes an input field, dynamic result display, step-by-step chain link calculations, and a diagram illustrating the addition process within chain links.

This table, titled “Table 1,” illustrates the doubling and halving of numbers from 0 to 9 using balloons as a visual aid. It clarifies that halving an odd number results in an integer by presenting undivided balloons. Doubling values are represented using black balloons;

This table, titled “Table 2,” visually explains the 9-Complement and 10-Complement concepts using balloons as illustrative aids. Black balloons represent numbers greater than 4, while white balloons represent numbers less than or equal to 4. The 9-Complement is calculated as 9-N, and the 10-Complement follows a similar formula, 10-N. The table utilizes undivided and grouped balloons to effectively differentiate between numbers and their respective complements;

FIG. 7 illustrates an example user interface of the ZMC 11 eLearning calculator for young learners, showing tabbed modes, an input/display area, a numeric keypad, a rule image, and language/help controls, along with a sample computation (11×2369=26059).

FIG. 8 illustrates an advanced version of the ZMC 11 calculator interface, showing multiple selection fields, a rule image, input controls, result panels, and operational buttons, all configured to support unlimited-digit multipliers while applying the same Zargelin Mathematical Chain (ZMC) principle used in earlier models.

FIG. 8A shows an example operation of the ZMC 11 Unlimited Digits Calculator using a 41-digit multiplier, demonstrating user entry, the displayed chain links, and the resulting ZMC 11 computation.

FIG. 8B illustrates an example operation of the ZMC 11 Unlimited Digits Calculator in Computer mode, where the system automatically generates a random 276-digit multiplier.

FIG. 9 consists of two concentric circles that illustrate the rules of the Zargelin Mathematical Chain (ZMC) method. The inner circle shows rules for ZMC methods with multiplicands×8 to ×12, where operations use the entire right digit without distinguishing between even and odd digits. The outer circle represents ZMC methods for multiplicands×3 to ×7, with sections divided into even and odd multiplier digits, where odd digits require adding 5. The circles are organized symmetrically, with a difference of 5 between the multiplicands in the inner and outer circles, such as 11 and 6, or 12 and 7, highlighting the similarities in the computational rules for easier memorization.

### DETAILED DESCRIPTION OF THE DRAWINGS

Reference will now be made to the drawings in which the various elements of the present invention will be given numeral designations and in which the invention will be discussed to enable one skilled in the art to make and use the invention.

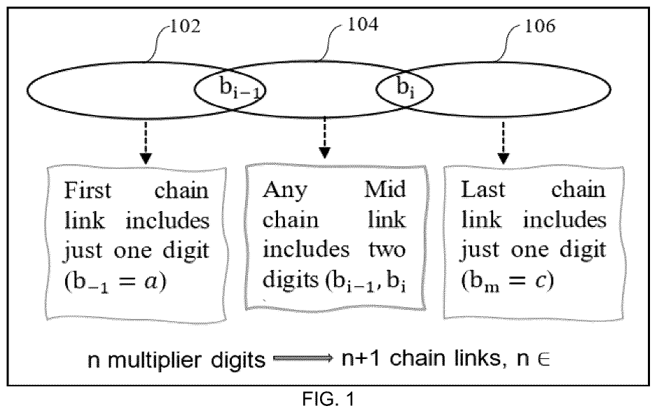

Referring to FIG. 1, the invented chain link structure is designed to assist individuals in performing multiplication calculations with precision and simplicity. The figure illustrates the components and arrangement of the chain links in the Zargelin Mathematical Chain (ZMC) method.

The first chain link, denoted as 102, includes a single digit labeled as b₋₁=α, representing the starting point of the computation. This chain link is distinct in its singularity, setting the stage for the sequential calculation process.

The mid-chain links, represented as 104, each include two digits, bᵢ₋₁ and bᵢ, which are interconnected to perform addition or other required operations during the multiplication process. These links form the core of the chain, bridging the digits and enabling the step-by-step progression of calculations from left to right.

The final chain link, labeled as 106, includes just one digit, bₘ=c, concluding the calculation. Similar to the first link, it operates independently, ensuring the process is complete without reliance on additional chain links.

In total, the ZMC method generates n+1 chain links for a multiplier consisting of nnn digits. This structure not only facilitates systematic calculations but also enhances efficiency by reducing the reliance on traditional multiplication tables. The arrangement of the chain links ensures a logical flow of operations, making the method intuitive and easy to use for learners and practitioners alike.

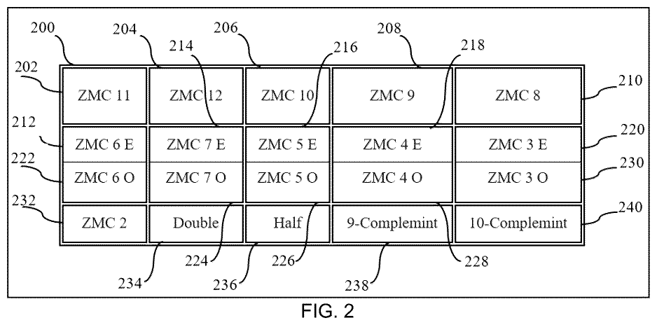

Referring to FIG. 2 (200), the schematic diagram represents the organization of the Zargelin Mathematical Chain (ZMC) system into sub-calculators and mathematical tools. Each section corresponds to a specific ZMC method or operation, designed to address various mathematical computations efficiently and intuitively. Users can select from this layout the desired ZMC sub-calculator, which determines the multiplicand to be used in the calculation.

The top row (200) includes primary ZMC methods such as ZMC 11 (202), ZMC 12 (204), ZMC 10 (206), ZMC 9 (208), and ZMC 8 (210), which are intended for standard multiplication processes. Below this row, the second row (212) features methods like ZMC 6 E (even, 214), ZMC 7 E (216), ZMC 5 E (218), ZMC 4 E (220), and ZMC 3 E (222), focusing on multiplication with even digits.

The third row (230) introduces methods like ZMC 6 O (odd, 224), ZMC 7 O (226), ZMC 5 O (228), ZMC 4 O (230), and ZMC 3 O (232), specifically targeting multiplication with odd digits. Additionally, the final row (240) highlights mathematical operations such as doubling (234), halving (236), finding 9-complements (238), and determining 10-complements (240).

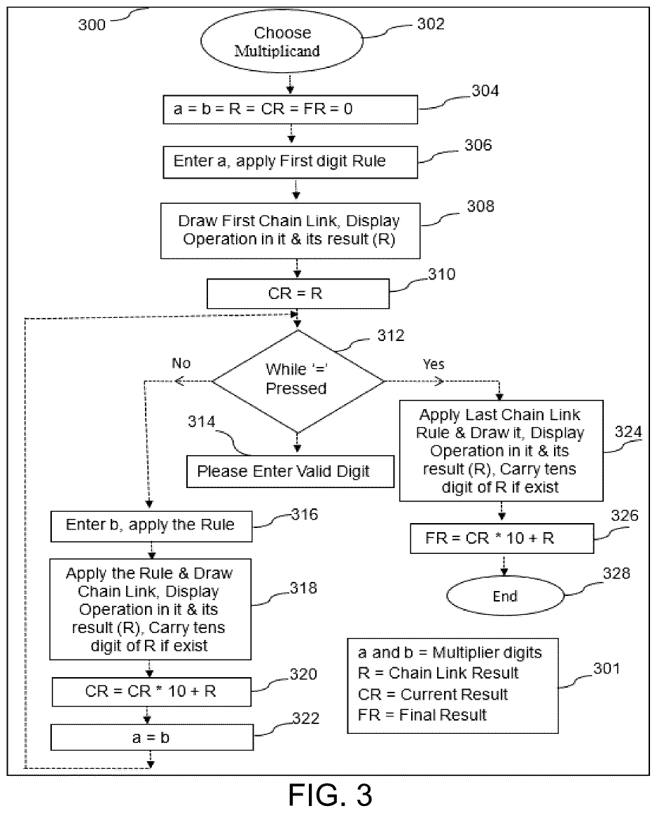

Referring to FIG. 3 (300), the process flowchart depicts the detailed sequence of steps for using the Zargelin Mathematical Chain (ZMC) method to perform multiplication. The process begins with the user selecting a multiplicand (302), followed by initializing variables such as.

At step 306, the user enters the first digit and applies the first digit rule. In step 308, the first chain link is drawn, and the operation within it is displayed along with its result. The current result is then updated to at step 310.

The user proceeds by entering subsequent digits (316), applying the rule for each, and drawing the corresponding chain links in step 318. During this step, the operation within the chain link is displayed, and the tens digit of is carried if it exists.

The last chain link is addressed at step 324, where the corresponding rule is applied, the chain link is drawn, and the operation along with its result is displayed. The tens digit of is carried if applicable.

Finally, the current result is used to compute the final result using the formula in step 326. The process ends at step 328.

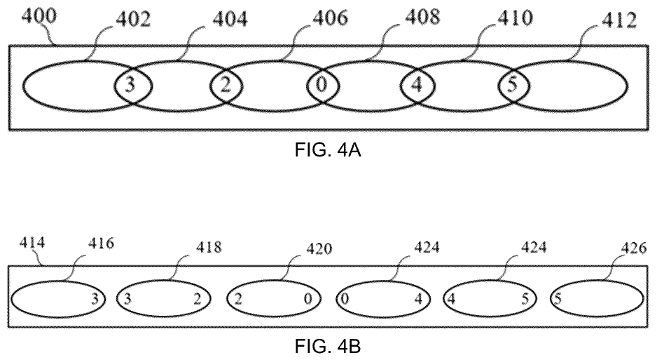

Referring to FIG. 4A (400), the diagram demonstrates overlapping chain links where each link shares a part of its structure with the adjacent link. Each chain link contains a single digit, with the first chain link starting at 402 and containing the digit 3, followed by 404 (digit 2), 406 (digit 0), 408 (digit 4), and 410 (digit 5). The overlapping nature of these links ensures continuity and demonstrates the sequential operations in the ZMC method.

Referring to FIG. 4B (414), the diagram illustrates separated chain links where each link is distinct and does not overlap with the next. The chain links begin at 416 (digit 3), followed by 418 (digit 2), 420 (digit 0), 424 (digit 4), and 426 (digit 5). This configuration emphasizes clarity by isolating each chain link for individual calculation.

Both configurations FIGS. 4A and 4B highlight the flexibility of the ZMC method, allowing for either overlapping or separate representations depending on user preference or instructional needs.

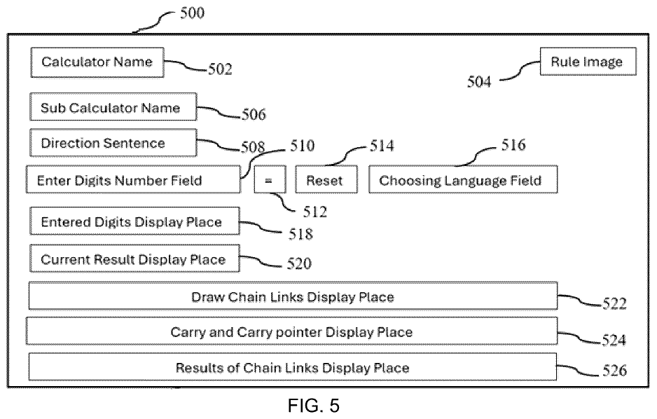

Referring to FIG. 5 (500), the diagram depicts the user interface of the ZMC calculator, which includes multiple components designed for ease of use. The Calculator Name field (502) displays the name of the tool to identify the current application. A Sub Calculator Name field (506) specifies the selected sub-calculator, providing clarity for users. The Rule Image field (504) offers a visual representation of the rule or operation associated with the chosen sub-calculator.

The interface also features a Direction Sentence field (508) to guide users on how to operate the calculator. An Enter Digits Number field (510) allows users to input the number of digits for the calculation, while the “=” button (512) initiates the calculation process. A Reset button (514) enables users to clear all inputs and results, returning the calculator to its default state. A Choosing Language field (516) provides the option to select a preferred language for the interface.

The Entered Digits Display Place (518) shows the digits input by the user, and the Current Result Display Place (520) updates dynamically to show the ongoing result of the calculations. The Draw Chain Links Display Place (522) visually represents the chain links as they are processed. The Carry and Carry Pointer Display Place (524) highlights any carry operations and their respective pointers. The Results of Chain Links Display Place (526) displays the calculated results for each chain link, providing a comprehensive overview of the calculation process.

This user interface layout ensures an intuitive and efficient experience for users, simplifying the process of performing calculations with the ZMC method.

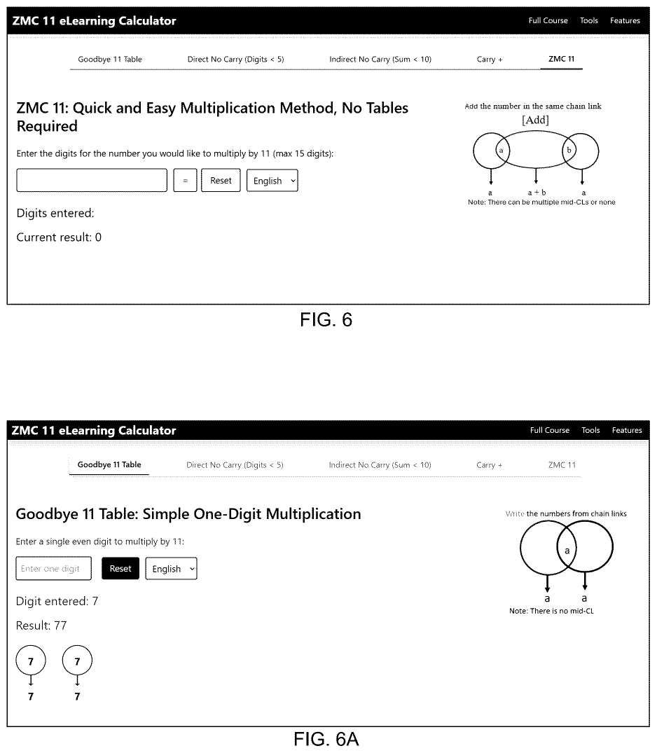

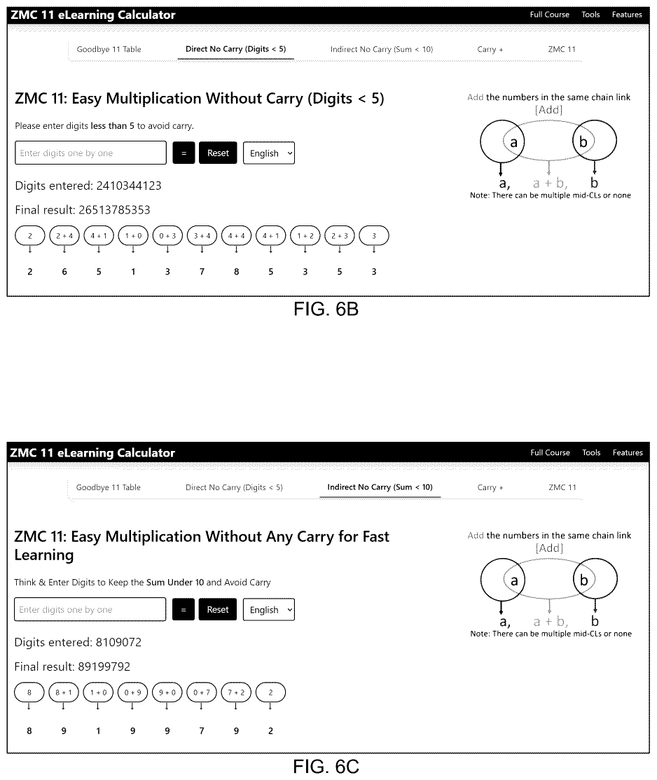

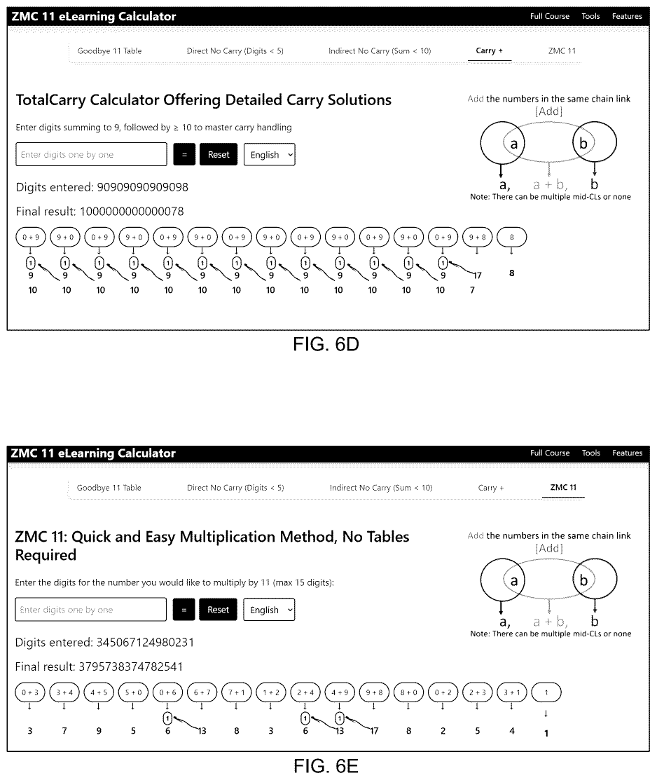

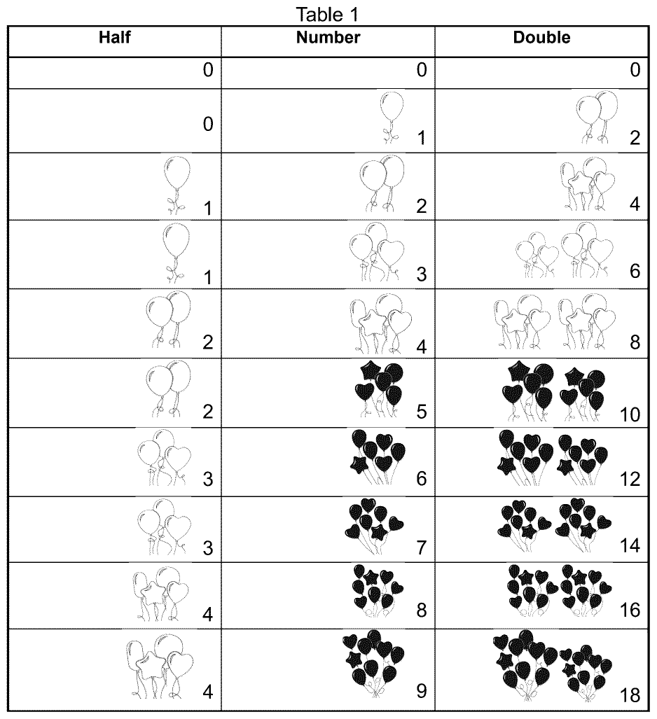

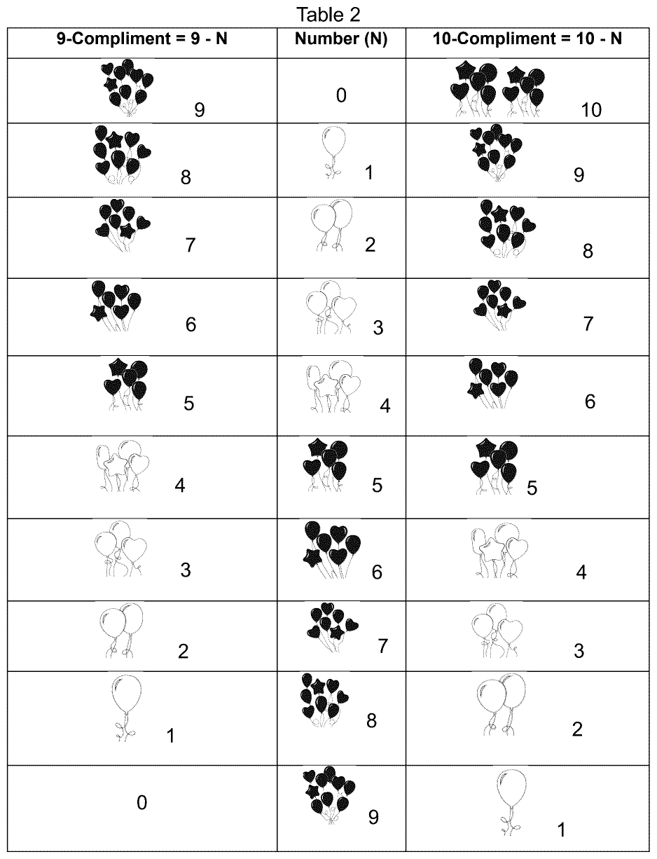

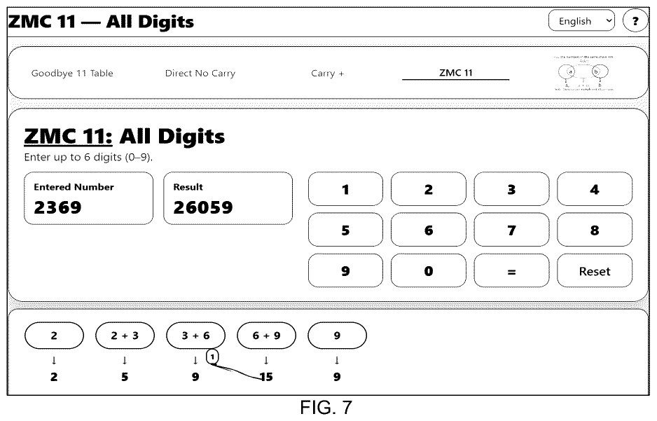

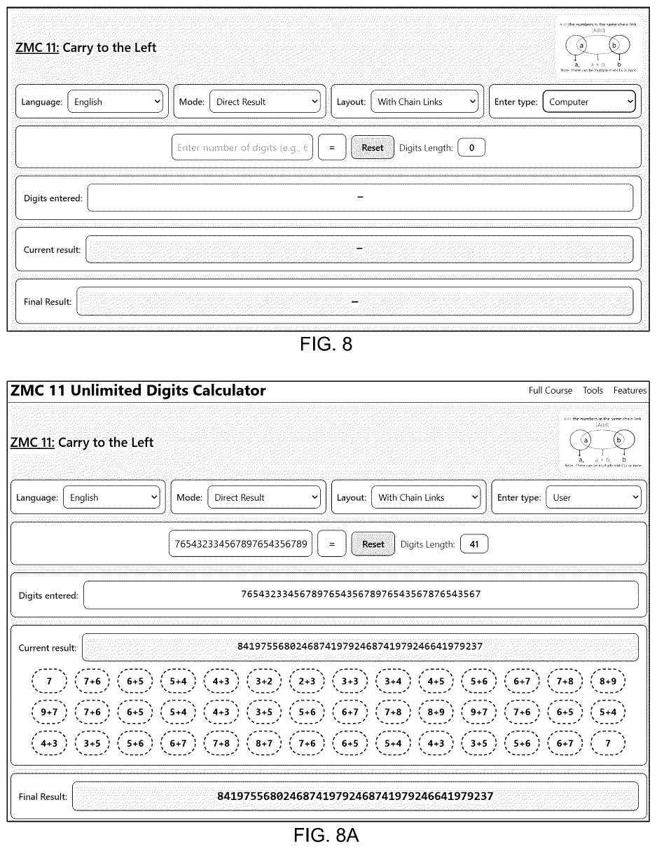

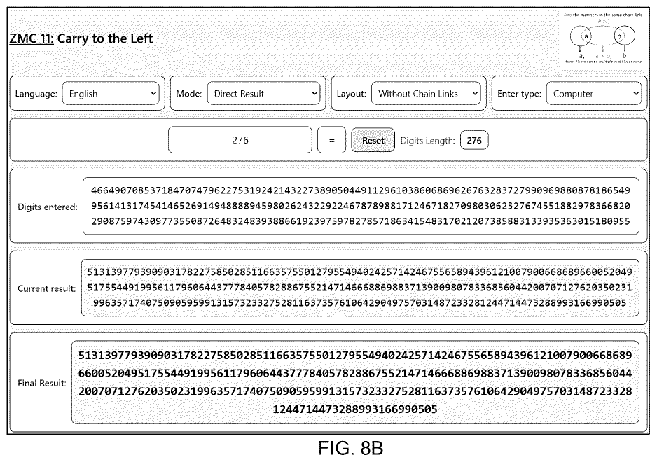

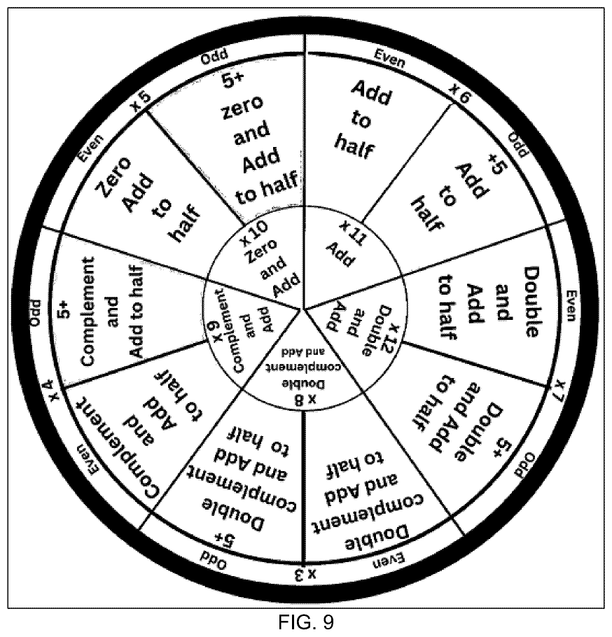

Referring to FIG. 6, the image illustrates the interactive interface of the ZMC 11 eLearning Calculator, designed to simplify multiplication by 11 without requiring the use of a multiplication table. The interface provides a user-friendly input field where digits can be entered one at a time, supporting up to 15 digits. Users can click the reset button to clear their entries and start over. A language dropdown menu is included to cater to a diverse audience.

The top navigation bar provides quick access to different modes, such as “Direct No Carry (Digits <5)” and “Carry +” to accommodate varying levels of complexity. The title emphasizes the efficiency and ease of the ZMC 11 method.

On the right-hand side, a visual guide demonstrates the chain-link method for calculating the multiplication. It uses a diagram to show how numbers within each chain link are added, with a, b, and a+b clearly labeled and color-coded for better understanding. The note below the diagram clarifies that there can be multiple mid-chain links or none, depending on the number of digits entered.

This design provides an educational and practical approach, enabling users to learn and apply the ZMC 11 method interactively while offering clear visual aids to enhance comprehension.

Referring to FIG. 6A, this interface represents the “Goodbye 11 Table” mode of the ZMC 11 eLearning Calculator, specifically designed for simple one-digit multiplication by 11. The purpose of this mode is to eliminate the need for memorizing the multiplication table for 11, providing users with a straightforward and visual method for performing these calculations.

The interface includes an input field where users can enter a single digit. Below this, the entered digit and the corresponding multiplication result are displayed. For example, when the digit 7 is entered, the result 77 is instantly shown. This provides real-time feedback, helping users understand the multiplication process interactively.

The reset button allows users to clear their input and restart, while the language selection dropdown ensures that the tool is accessible to a global audience by offering multiple language options. The navigation bar at the top features other calculation modes, such as “Direct No Carry (Digits <5)” and “ZMC 11,” catering to different levels of complexity and use cases.

On the right-hand side, a diagram explains the process of one-digit multiplication by 11. The chain link representation visually demonstrates how the number is duplicated and distributed across two chain links, represented by circles. In this example, the number a (7) is placed in both chain links, showing that for one-digit multiplication by 11, there is no mid-chain link (mid-CL), as indicated by the note below the diagram.

This visual and textual combination simplifies the concept, making it easy for learners to grasp and apply. The “Goodbye 11 Table” mode not only facilitates quick calculations but also reinforces the understanding of the multiplication process through intuitive design and engaging visual aids.

Referring to FIG. 6B, this interface represents the “Direct No Carry (Digits <5)” mode of the ZMC 11 eLearning Calculator. This mode is specifically designed to facilitate multiplication by 11 when all entered digits are less than 5, ensuring that no carry operations are required. This feature is ideal for fast and accurate learning, eliminating the need to account for carrying during calculations.

The interface begins with an input field where users can enter digits one by one. A reset button is provided to clear the input and restart the calculation process, and a language selection dropdown is included for accessibility to a broader audience. Below the input field, the digits entered and the calculated final result are displayed in real time, allowing users to follow the process interactively.

The calculation results are broken down into chain links, which are displayed below the result. Each chain link corresponds to two digits connected for addition, with their sums color-coded and visually separated for clarity. For example, when the digits “2410344123” are entered, the chain link sums are shown as 2, 2+4, 4+1, 1+0, and so on, with the intermediate sums leading to the final result of 26513785353.

On the right-hand side, a diagram illustrates the chain link method. Each link visually represents how two digits (a and b) are added to produce a result, with a note emphasizing that there can be multiple mid-chain links or none. This diagram reinforces the conceptual understanding of the ZMC 11 method.

This mode offers a streamlined and efficient approach to multiplication by 11, particularly for numbers with digits less than 5. The combination of real-time feedback, clear visual aids, and structured chain link calculations makes this tool an effective educational resource for learners

Referring to FIG. 6C, this interface illustrates the “Indirect No Carry (Sum <10)” mode of the ZMC 11 eLearning Calculator, which simplifies multiplication by 11 by ensuring that the sum of digits in each chain link is less than 10. This feature allows users to avoid carry operations, making the process more straightforward and intuitive.

The interface begins with an input field for entering digits one by one. Below it, a reset button clears the input, allowing users to start over, while a dropdown menu provides language selection for accessibility. The “Digits entered” and “Final result” sections dynamically display the input and calculation result. For example, when the digits “8109072” are entered, the final result is calculated as “89199792.”

Chain link calculations are detailed below the result, showing the addition performed for each link. The sums are color-coded for clarity and presented step-by-step. For instance, the first chain link adds 8+1=9, and the next adds 1+0=1, continuing until the “=” button is pressed. At that point, the final chain link calculation appears, and the final result replaces the current result in the display. Each step ensures the sum remains under 10 to avoid carrying.

A diagram on the right visually explains the chain link addition process. Using overlapping circles, it represents how each digit (a and b) is added within the same chain link, with the sum displayed in between. The note clarifies that there can be multiple mid-chain links depending on the number of digits entered, but no carry operations are involved.

This mode is ideal for users who want to practice multiplication by 11 while focusing on simple, carry-free additions. Its structured design, real-time feedback, and visual aids make it an effective educational tool for learners of all levels.

Referring to FIG. 6D, this interface represents the “Carry +” mode of the ZMC 11 eLearning Calculator, specifically designed to teach and demonstrate the handling of carry operations in multiplication by 11. This mode emphasizes scenarios where the sum of digits in a chain link exceeds 9, necessitating a carry to the previous chain link.

The interface begins with an input field for entering digits one by one. A reset button clears the input, and a language selection dropdown ensures accessibility to a wide audience. As digits are entered, the “Digits entered” section dynamically displays the sequence of numbers, and the “Final result” section updates in real time, reflecting the calculations performed.

The chain link calculations are displayed below the result, breaking down each addition step by step. When the sum of two digits in a chain link exceeds 9, the carry operation is explicitly shown. For instance, in the input sequence “90909090909098,” the chain link 9+0=9 does not trigger a carry, but the chain link 9+8=17 results in a carry of 1, which is added to the previous result, which itself is 9, causing an additional carry. This cascading effect is clearly demonstrated, with each carry and its impact explicitly illustrated and color-coded for clarity.

A diagram on the right visually explains the chain link and carry process. Each chain link connects two digits (a and b), with the sum (a+b) calculated within the link. When the sum exceeds 9, the carry is shown as a separate operation, flowing back to the previous link. The note below the diagram emphasizes that there can be multiple mid-chain links or none, depending on the input digits.

This mode is ideal for learners seeking a deeper understanding of carry operations in multiplication. The clear breakdown of calculations, combined with dynamic feedback and visual aids, provides an engaging and educational experience, reinforcing key concepts for mastering multiplication by 11.

Referring to FIG. 6E, this interface illustrates the ZMC 11 mode of the ZMC 11 eLearning Calculator, which is a comprehensive tool for performing multiplication by 11 for numbers up to 15 digits. This mode supports handling carry operations when the sum of digits in a chain link exceeds 9, ensuring accurate calculations for larger numbers.

The interface includes an input field for users to enter digits one at a time, with a reset button to clear the input and a language dropdown menu for accessibility. As digits are entered, the “Digits entered” section displays the sequence of numbers dynamically, and the “Final result” section updates to show the complete calculation result. For example, the digits “345067124980231” produce the final result of “3795738374782541.”

The chain link calculations are presented below the result, detailing each addition step and highlighting carry operations. For instance:
The chain link 6+7=13 results in a carry of 1, which is added to the previous chain link's result.
The carry from 4+9=13 propagates back, creating an additional carry.
The cascading effect of carries is visually represented, ensuring learners understand the step-by-step process. Each chain link and its result are color-coded for clarity, and carry operations are explicitly shown with arrows indicating their flow back to the previous link.

A diagram on the right provides a visual explanation of the chain link process, where each pair of digits (a and b) is added within a chain link, and the carry, if any, is returned to the previous link. The note clarifies that multiple mid-chain links may exist depending on the number of digits entered.

This mode is ideal for learners who want to understand multiplication by 11 with both basic and complex scenarios involving carry operations. The step-by-step calculations, real-time feedback, and visual aids make it an effective and engaging educational tool.

FIG. 7 shows an example layout of a ZMC 11 eLearning calculator designed to teach and practice the Zargelin Mathematical Chain (ZMC) multiplication method by 11. The interface is organized into distinct functional regions so that children can easily navigate between learning modes and perform calculations with minimal cognitive load.

At the top of the interface, a tab bar provides access to multiple sub-calculators, such as “Goodbye 11 Table,” “Direct No Carry,” “Carry+,” and “ZMC 11.” Selecting a tab activates the corresponding mode while maintaining the same overall structure. Each mode applies the ZMC principle but may differ in instructional focus, visual presentation, or allowed digit rules (e.g., carry-free versions). Below the tab bar, the active ZMC 11 mode is displayed. The central output area includes two labeled fields:
1. Entered Number Field—This box displays the digits entered by the user. The system accepts both button presses on the keypad and direct keyboard typing, allowing children or instructors to enter up to six digits (0-9) in any order.
2. Result Field—This box shows the computed product using the ZMC 11 method. As an example, the figure shows the input 2369 and the resulting multiplication 26059, demonstrating the calculation 11×2369=26059 through the neighboring-digit addition chain.

To support child-friendly interaction, a numeric keypad is provided with buttons for digits (0-9), an equal (=) button, and a reset button. The keypad's layout resembles that of a conventional hand-held calculator, giving learners a familiar structure. When the user presses a button or types a digit on the keyboard, the system updates the Entered Number field immediately and computes the ZMC 11 intermediate or final result as appropriate.

A rule image appears on the same screen. This image visually summarizes the ZMC 11 chain-link operation by showing how each digit is paired with the next one to perform left-to-right addition. The rule image serves as a compact reminder of the method and helps children follow the logic behind the displayed steps.

A help button, shown with a “?” icon, can be selected to open a help window or instructional overlay. This help view may explain the ZMC 11 rule, show intermediate worked examples, or guide new learners through the chain-link process used in the method.

On the upper right side of the figure, a language-selection field (e.g., a drop-down menu) allows the interface labels, tab names, titles, and help text to be instantly switched between multiple languages. Only the visible text changes; the underlying ZMC 11 engine and keypad functionality remain identical across languages.

Together, these elements the tab bar, input fields, result display, keypad, rule image, help button, and language selector form a structured, child-oriented environment for demonstrating and practicing the ZMC 11 multiplication technique in an intuitive and visually guided manner.

FIG. 8 shows an advanced graphical user interface for the ZMC 11 calculator. This model offers expanded functionality compared to earlier child-focused versions, while still operating according to the same Zargelin Mathematical Chain (ZMC) rule: neighboring-digit addition with carry to the left. The design allows users to perform ZMC 11 multiplication for any number of digits, including very large multipliers, while providing flexible configuration options suited for students, educators, and advanced learners.

At the top of the interface, the title “ZMC 11: Carry to the Left” indicates the active mode, consistent with the ZMC 11 chain-link principle. Adjacent to the title, a rule image visually summarizes the ZMC 11 operation by showing two connected chain links labeled a and b, and the resulting a+b. This image remains on screen at all times to reinforce the conceptual rule as users experiment with more complex or unlimited-digit inputs.

Beneath the title, several selection fields allow customization of the calculator's behavior:
1. Language Selector—A drop-down field enabling users to switch the interface text to multiple languages. Changing the language updates all labels, descriptions, and button names while leaving the underlying computational logic unchanged.
2. Mode Selector—Users may choose between Direct Result and Indirect Result modes. In Direct Result mode, the intermediate and final results appear as digits are entered. In Indirect Result mode, results remain hidden until the equals button is pressed, supporting instructional or testing use.
3. Layout Selector—This field toggles between With Chain Links and Without Chain Links, allowing users to visualize the chain-link operations beneath each calculation or hide them for a cleaner interface.
4. Enter Type Selector—Allows users to choose between Computer (system generates a random multi-digit number) or User (the user manually enters digits). This enables traditional entry, automated practice, or high-speed random testing.
   Below the selectors, a large input section includes:
A main entry field where users either type digits directly or, in Computer mode, specify the number of digits to be generated (e.g., 6, 102, 920, 12765 or more).
An equals (=) button to compute and display the full ZMC 11 result.
A Reset button to clear the input, reset the chain links, and restore all fields.
A Digits Length indicator, which updates dynamically to show the current number of entered digits or the requested length in Computer mode.
   Further down, the interface includes three horizontally aligned panels:
1. Digits Entered Panel-Displays the entered or generated digits exactly as they were supplied, allowing the user to track and verify each step.
2. Current Result Panel-Shows the evolving result during digit entry in Direct mode. When chain links are enabled, this panel may also reflect live carry-left operations.
3. Final Result Panel-Displays the completed multiplication result after pressing the equals button in either mode, suitable for checking multi-digit or unlimited-digit outputs.

When With Chain Links is selected, the advanced model dynamically displays chain-link diagrams beneath the result panels, showing each a+b pair and any carry propagation. This visualization helps users understand the logic even when working with 20, 40, or 100 or more-digits multipliers.

Because this advanced version supports typing or generating any number of digits, it extends the ZMC 11 method beyond simple instructional use and allows demonstration of the scalability of the Zargelin Mathematical Chain for arbitrarily large multipliers. Despite its expanded controls and flexibility, the calculator maintains the same underlying rule as previous models: each digit forms a chain link with the next, the pair is added, and any tens value is carried left.

Together, the language controls, mode controls, layout options, digit-entry flexibility, dynamic chain-link visualization, and unlimited-digit capability make FIG. 8 an advanced, configurable interface built upon the same ZMC 11 principle demonstrated in earlier simpler examples.

FIG. 8A illustrates an example where the user enters a 41-digit number “765432333456789765435678976543567876543567” into the ZMC 11 Unlimited Digits Calculator.

The Digits Entered field displays all 41 digits exactly as typed. The Current Result field shows the ongoing ZMC 11 calculation for all chain links.

Below the result, the interface displays each chain link, where every pair of neighboring digits is shown in its own dashed circle (e.g., 7+6, 6+5, 5+4, 4+3, etc.), including the first and last digits in single-digit chain-link circles. As each new digit is entered, its corresponding chain link is immediately drawn and the intermediate result is updated in real time. This process continues digit by digit until the user presses the “=” button, at which point the final chain link is drawn and the Final Result field displays the completed ZMC 11 computation:
841975568024687419792468741979246641979237

This figure demonstrates that the advanced ZMC 11 model supports long-digit inputs, displays all intermediate chain-link operations, and applies the same left-carry ZMC principle regardless of the multiplier length.

FIG. 8B shows the calculator configured in Computer mode, in which the user enters only the desired digit count, and the system automatically generates a random multiplier. In this example, a value of 276 digits is selected, and the full randomly generated sequence appears in the “Digits entered” field exactly as displayed in the figure. The calculator processes all digits using the ZMC 11 rule and presents the intermediate and final results in their respective panels.

A 276-digit example is chosen so that the entire entered number, current result, and final result can be displayed within the computer screen layout, as shown in the figure.

Referring to Table 1, this visual representation illustrates the concepts of halving and doubling numbers from 0 to 9 using balloons as an engaging and intuitive aid. The table is divided into three columns: the left column displays the halved values, the center column represents the numbers (N) from 0 to 9, and the right column showcases the doubled values.

In this representation, black balloons denote doubled values, while white balloons represent halved values. This distinction is designed to provide a clear visual separation between the two operations.

The left column calculates the half of each number N. For even numbers, the halved value is an integer, represented by grouped white balloons. For odd numbers, the halved value is rounded down to the nearest integer (integer division), with undivided white balloons symbolizing the remaining portion. For example, when N=7, the halved value is 7+2=3 (integer result), displayed as three grouped white balloons.

The right column calculates the double of each number N, where the value is represented by black balloons. For example, when N=5, the doubled value is 5×2=10, represented by ten black balloons.

The center column shows the numbers (N) from 0 to 9, providing a clear reference point for the corresponding halved and doubled values. The consistent layout allows for easy cross-referencing between the halved, original, and doubled values.

This table serves as an educational tool for visualizing the mathematical operations of halving and doubling, enhancing comprehension and making abstract concepts accessible. By associating these operations with balloons, it creates an interactive and memorable learning experience.

Referring to Table 2, this visual representation illustrates the concepts of 9-Complement and 10-Complement using balloons to enhance understanding and engagement. The table is divided into three columns: the left column represents the 9-Complement values, the center column displays the numbers (N) from 0 to 9, and the right column represents the 10-Complement values.

In this representation, black balloons are used to denote numbers greater than 4, while white balloons signify numbers less than or equal to 4. This distinction visually emphasizes the difference between higher and lower values.

The 9-Complement is calculated as 9-N, and the corresponding complement is displayed in the left column. For example, when N=5, the 9-Complement is 9−5=4, represented by four white balloons. Similarly, the 10-Complement, calculated as 10-N, is displayed in the right column. For example, when N=5, the 10-Complement is 10−5=5, represented by five black balloons.

The use of grouped and undivided balloons in the table provides clarity in differentiating numbers from their complements. Numbers are visually presented in the middle column, while their respective complements are displayed to the left and right, making it easy to cross-reference and understand the relationship between numbers and their complements.

Referring to FIG. 9, the drawing features two concentric circles that represent the rules for different Zargelin Mathematical Chain (ZMC) methods. The inner circle contains rules for multiplicands×8 to ×12, where the operations involve adding the entire right digit without distinguishing between even and odd digits. This simplifies the calculations and ensures uniformity for these higher multiplicands.

The outer circle displays rules for ZMC methods with multiplicands×3 to ×7. Each segment in the outer circle is divided into two parts: one for even multiplier digits and another for odd digits. The computations for odd digits require an additional step of adding 5 to the result, making these rules slightly more specific. For example, ZMC 6 uses “add to half” for even digits and “add to half+5” for odd digits, while ZMC 5 uses “zero and add to half” for even digits and “zero and add to half+5” for odd digits.

The circles are designed with a consistent difference of 5 between corresponding multiplicands in the inner and outer circles, such as 11 and 6, 12 and 7, or 9 and 4. This structure emphasizes the similarities between the rules, such as ZMC 11 using “add” while ZMC 6 uses “add to half,” making the ZMC method systematic and easy to memorize. The arrangement of rules within the circles also helps users quickly identify the appropriate computation for any given multiplicand and multiplier. This visualization demonstrates the efficiency and clarity of the ZMC method, providing a structured and intuitive approach to multiplication without relying on traditional multiplication tables.

### DETAILED DESCRIPTION

The invention consists of a Multiplication eLearning Calculator that applies the Zargelin Mathematical Chain (ZMC). The design is centered around an easy-to-use interface where users input digits one by one, and the calculator visually draws the chain links as each digit is entered. Each chain link represents a step in the multiplication process, showing the individual operations performed on neighboring digits. The results are displayed alongside the chain links, with arrows (pointers) indicating the connections between chain links and digits, making it easy for users to follow each step visually.

The design is intended to simplify the learning experience, especially for younger students. In addition to showing the step-by-step results, the calculator displays any carry operations when they occur. A special carry pointer is drawn next to the chain link to indicate when and where the carry occurs. This visualization is particularly useful for helping children understand the concept of carrying digits during multiplication.

To further simplify the process and ensure it is easy for children to use, two separate versions of the calculator have been created. The first version enforces a strict rule where each digit entered must be less than a specific value, ensuring that no carry-over will occur. For example, when multiplying by 11 (ZMC 11), the entered digits must be less than 5 to guarantee that the sum of neighboring digits is always less than 10. This version eliminates the need for carry operations entirely, making it ideal for beginners or small children who are just learning multiplication understood the ZMC rules.

The Indirect No Carry version offers more flexibility, allowing users to enter any digits while still managing carry-up operations efficiently. This ensures that there are no carry appears, simplifying the calculation process for the user. For example, if the current chain link includes digits 1 and 8 (which sum to 9), the next entered digit must be 0 or 1 to ensure that the sum, when added to 8, remains less than 10, thereby avoiding carry.

Although the Zargelin Mathematical Chain (ZMC) is applicable to numbers of infinite length, we have limited the input to 15 digits only (users can input numbers up to 15 digits long) to save users' time and avoid unnecessary operations. The calculator displays the result and illustrates the step-by-step progression of the calculation, highlighting how each digit interacts with its neighboring digits through the chain links. Additionally, the pointer shows the flow of operations, providing real-time feedback that makes it easier for users to understand the concept of multiplication and derive results without needing to memorize traditional multiplication tables.

All sub versions of the calculator are designed to provide a clear and engaging visual learning experience, making multiplication more accessible and enjoyable for learners of all ages. The addition of conditions for digit input (in the Direct No Carry and Indirect No Carry) and the management of carry operations (in Carry+) ensures that users can learn multiplication in a controlled environment, gradually increasing their understanding and confidence.

The user interface also includes language support and adjustable difficulty levels, making the calculator suitable for use in various educational settings. The combination of clear visual aids, step-by-step calculations, and conditional input makes this Multiplication Learning Calculator a powerful tool for teaching and practicing multiplication in an engaging, effective way.

This tool not only simplifies multiplication but also encourages deeper mathematical comprehension by allowing students to see the connections between digits, understand the purpose of carrying, and grasp the overall flow of calculations. Through real-time visual feedback, learners can better understand both the process and the result, making this calculator a valuable addition to the educational resources available for teaching multiplication.

Table 2 provides a comprehensive summary of all the rules for the multiplicand-parts calculator. The multiplicand values are listed in the first column on the left and are multiplied by the multiplier sequences (a:bi:c). The second row outlines the three distinct result sections. The first and last columns focus on operations involving a single digit, while the middle column manages the calculations for two digits at each step of the process. This layout ensures clarity in how each part of the multiplicand interacts with the multiplier and contributes to the overall result.

This table acts as a calculation reference for all three mentioned scenarios. In the first scenario, particularly when showing how to convert a single multiplicand digit (2<dv<10) into two multiplicand digits, the middle digits column should be disregarded, focusing only on the ‘a’ and ‘c’ columns. Row 6 in the table clearly illustrates the detailed calculations and serves as definitive proof of the effectiveness and accuracy of the RFM-6a method. It demonstrates how the multiplication between the number 6 and any single-digit integer can be computed without directly performing the multiplication operation.

TABLE 2

| | a | bi | c | |
|---|---|---|---|---|
| * | The left digit= | Middle digits= | One's digit= | m |
| 12 | a | bi + 2 bi − 1 | 2c | 1 |
| 11 | a | bi + bi − 1 | c | 2 |
| 9 | a − 1 | bi + (9 − bi − 1) | 10 − c | 3 |
| 8 | a − 2 | bi + 2(9 − bi − 1) | 2(10 − c) | 4 |
| 7 | a/2 | bi/2 + 2 bi − 1 E | 2c E | 5 |
| | (a − 1)/2 | bi/2 + 2 bi − 1 + 5 O | 2c + 5 O | |
| 6 | a/2 | bi/2 + bi − 1 E | c E | 6 |
| | (a − 1)/2 | bi/2 + bi − 1 + 5 O | c + 5 O | |
| 5 | a/2 | bi/2 if bi − 1 E | O E | 7 |
| | (a − 1)/2 | bi/2 + 5 if bi − 1 O | 5 O | |
| 4 | (a/2) − 1 | bi/2 + 2(9 − bi − 1) E | 10 − c E | 8 |
| | (a − 1)/2 | bi/2 + 2(9 − bi − 1) + 5 O | 10 − c + 5 O | |
| 3 | (a/2) − 2 | bi/2 + 2(9 − bi − 1) E | 2(10 − c) E | 9 |
| | (a − 1)/2 | bi/2 + 2(9 − bi − 1) + 5 O | 2(10 − c) + 5 O | |
| 2 | a + a | bi + bi | c + c | 10 |

Not:
E for Even and O for Odd

### Direct No Carry For ZMC Methods

The Direct No Carry ZMC methods are specifically designed to simplify multiplication by ensuring that sums in chain links remain below 10 without any thinking, eliminating the need for carry operations. For ZMC 8 to ZMC 11, the method works seamlessly with all multipliers, as the calculations naturally avoid exceeding single-digit sums. However, for ZMC 3 to ZMC 7, the method is restricted to even multipliers only, as odd multipliers require the addition of 5, which often causes the sum to exceed 9, introducing carry operations. This approach provides an efficient, straightforward solution for rapid and accurate multiplication.

Version Direct No Carry of the ZMC 11 multiplication method achieves carry-free computation by imposing a constraint where each digit in the number is less than 5. This ensures that the sum of any two adjacent digits (a+b) remains strictly below 10, eliminating carry operations and simplifying the calculation process. For instance, the maximum sum occurs when a=4 and b=4, resulting in a+b=8, which is well below the carry threshold. This constraint enhances computational efficiency and streamlines processing by removing the need to handle carry operations at any step.

The ZMC 6E multiplication method achieves direct no-carry computation by applying the rule a+b/2. To ensure 100% carry-free computation, the sum a+b/2 must remain strictly less than 10. Since the maximum value of b/2 is 4, the first term aa must satisfy a<6 to ensure the total remains below 10. Therefore, for direct no-carry computation, a, b∈{0, 1, 2, 3, 4, 5} guaranteeing efficient calculations without generating carry operations.

The ZMC 12 multiplication method ensures direct no-carry computation under the rule 2a+b by constraining a∈{0, 1, 2, 3}. For a=4, 2a=8, and b=4, the sum exceeds 10, so a≥4 is not allowed. By limiting a to less than 4 and ensuring b<10−2a. Therefore, for direct no-carry computation, a, b∈{0, 1, 2, 3}, guaranteeing efficient calculations without generating carry operations.

The ZMC 7 multiplication method achieves direct no-carry computation by applying the rule 2a+b/2. To ensure 100% carry-free computation, the sum 2a+b/2 must remain strictly less than 10. Since the maximum value of b/2 is 4, the first term 2a must be less than 6 to ensure the total remains below 10. This condition is satisfied when a<3. Therefore, for direct no-carry computation, a∈{0, 1, 2}, ensuring efficient calculations without generating carry operations.

The ZMC 9 multiplication method ensures direct no-carry computation under the rule 9−a+b by requiring a=b. When a=b, the sum simplifies to 9−a+a=9, which ensures that the result remains strictly less than 10, eliminating the possibility of a carry. Therefore, for direct no-carry computation, a=b, maintaining efficient and carry-free operations.

The ZMC 4E multiplication method ensures 100% carry-free computation by using the rule (9−a)+b/2, where a=bᵢ and b=bᵢ+1. To guarantee no carry, the sum of 9−a and b/2 must remain strictly less than 10. Since the maximum value of b/2 is 4, the first term 9−a must be less than 5, which is satisfied when a>3. Therefore, for direct no-carry computation, a, b∈{4, 5, 6, 7, 8, 9}, ensuring efficient calculations without generating carry operations. The ZMC 8 multiplication method achieves direct no-carry computation by applying rule 2(9−a)+b. To ensure 100% carry-free computation, the sum 2(9−a)+b must remain strictly less than 10. Since the maximum value of b is 9, the first term 2(9−a) must be less than 1 to keep the total below 10. This condition is satisfied only when a−9. Therefore, for direct no-carry computation, a, b=9, ensuring efficient calculations without generating carry operations.

The ZMC 3E multiplication method achieves direct no-carry computation by applying the rule 2(9−a)+b/2. To ensure 100% carry-free computation, the sum 2(9−a)+b/2 must remain strictly less than 10. Since the maximum value of b/2b/2 is 4, the first term 2(9−a) must be less than 6. This is satisfied when 9−a<3, which simplifies to a>6. Therefore, for direct no-carry computation, a, b∈{7, 8, 9}, ensuring efficient calculations without generating carry operations.

Table 3 summarizes the conditions for preventing carry operations in various Zargelin Mathematical Chain (ZMC) methods. Each method operates within specific rules to maintain carry-free computation. For example, methods like 12 and 11 restrict the digits a and b remains below the carry threshold. Methods like 10 and 5E allow any number for bb, while

TABLE 3

| | Multiplier sequence (consisting of the left digit a, and | Condition to prevent | |
|---|---|---|---|
| * | the right digit b) within each chain link | carry operations | m |
| 12 | 2a + b | a, b ∈ {0, 1, 2, 3) | 1 |
| 7E | $2 a + ( \frac{b}{2} )$ | a, b ∈ {0, 1, 2} | 2 |
| 11 | a + b | a, b ∈ {0, 1, 2, 3, 4} | 3 |
| 6E | $a + ( \frac{b}{2} )$ | a, b ∈ {0, 1, 2, 3, 4, 5, 6} | 4 |
| 10 | zeros + b | any number | 5 |
| 5E | $zeros + ( \frac{b}{2} )$ | any number | 6 |
| 9 | (9 − a) + b | Same number | 7 |
| 4E | $( 9 - a ) + ( \frac{b}{2} )$ | a, b ∈ {4, 5, 6, 7, 8, 9} | 8 |
| 8 | 2(9 − a) + b | a, b = 9 | 9 |
| 3E | $2 ( 9 - a ) + ( \frac{b}{2} )$ | a, b ∈ {7, 8, 9} | 10 |
| 2 | Test b and double a | a, b ≠ 9 | 11 |

others, such as 9, require aa and bb to be the same. Advanced methods like 8 and 3E impose stricter constraints on aa and bb to ensure carry-free results. Note: ZMC for odd multipliers less than 8 (e.g., 3, 5, 7) is not possible under direct no-carry conditions, as the rules require adding 5, which inevitably exceeds the carry threshold. These conditions simplify calculations, making the process more efficient and accurate.

Table 4 summarizes the various Zargelin Mathematical Chain (ZMC) versions and their key features. Each version is evaluated against several criteria: the “Goodbye

TABLE 4

| | Goodbye | Direct | Indirect | | | |
|---|---|---|---|---|---|---|
| * | Multiplication Table | No Carry | No Carry | Detailed | ZMC | m |
| 12 | ✓ | ✓ | ✓ | ✓ | ✓ | 1 |
| 7 | ✓ | ✓ | ✓ | ✓ | ✓ | 2 |
| 11 | ✓ | ✓ | ✓ | Carry+ | ✓ | 3 |
| 6 | ✓ | ✓ | ✓ | ✓ | ✓ | 4 |
| 10 | ✓ | X | X | X | ✓ | 5 |
| 5 | ✓ | X | X | ✓ | ✓ | 6 |
| 9 | ✓ | X same # | ✓ | ✓ | ✓ | 7 |
| 4 | ✓ | ✓ | ✓ | ✓ | ✓ | 8 |
| 8 | ✓ | X | ✓ | ✓ | ✓ | 9 |
| 3 | ✓ | ✓ | ✓ | ✓ | ✓ | 10 |
| 2 | ✓ | ✓ | ✓ | X | ✓ | 11 |

Multiplication Table” feature, the ability to perform direct and indirect calculations without carry, the inclusion of detailed explanations, and whether it utilizes the ZMC methodology. All versions include the “Goodbye Multiplication Table” feature, reflecting the universal applicability of the method. Versions for multiplying by 12, 7, 6, 4, and 3 offer comprehensive functionality, supporting both direct and indirect no-carry operations and detailed explanations. The version for multiplying by 11 uniquely includes an advanced carry-handling feature in addition to other functionalities. While some versions, like those for 10, 5, 9, and 8, have limitations in no-carry operations or detailed explanations, they still incorporate the ZMC methodology, making them consistent with the method's principles. Overall, the table highlights the adaptability and diverse capabilities of the ZMC versions across different multiplication scenarios.

### Illustrative Examples For ZMC Methods

The following examples illustrate the application of ZMC methods for different multiplicands, highlighting the variations in rules depending on the multiplicand (ZMCx). These methods demonstrate how to compute multiplication efficiently without relying on traditional multiplication tables, by breaking the process into structured steps using chain links.

For ZMC methods where the multiplicand is greater than 8 and less than or equal to 12 (e.g., ZMC 9, ZMC 10, ZMC 11 and ZMC12), the rule involves adding the entire right digit to the computation at each step. Conversely, for ZMC methods where the multiplicand is 8 or smaller (e.g., ZMC 8, ZMC 7, ZMC 6), the rule incorporates adding only half of the right digit, taking the integer part and ignoring any fractional value (e.g., 0.5 is discarded).

Additionally, across all ZMC methods, an important condition applies: if the previous digit (left digit in the chain link) is odd, 5 must be added to the result of the computation for the current chain link. This ensures proper handling of intermediate results and maintains accuracy throughout the calculation process.

For all the example tables, the second column from the left represents the multiplier, which corresponds to the entered digits in real ZMC applications. The third column presents the ZMC rule applied at each step, providing clarity on the computational logic. The final result is determined by appending the last step's result to the cumulative current result, demonstrating how ZMC methods operate in real time. Notably, ZMC methods do not require knowledge of the multiplier's size or the values of its digits beforehand, further showcasing their efficiency and adaptability for a wide range of calculations.

Table 5 demonstrates a real example from ZMC 11 direct no-carry computation, as illustrated in FIG. 6c, which is a real image, of ZMC 11 direct no carry example. It showcases the step-by-step calculation process for the multiplier 2410344123, adhering to the direct no-carry condition where each digit aa and bb is constrained to values less than 5. The table highlights how the rule a+b is applied at each step, with the current result being iteratively updated using the formula current result=current result×10+step result. This ensures that no carry operation is generated throughout the computation, demonstrating the efficiency and accuracy of the ZMC 11 method in practical applications.

TABLE 5

| | | | Current | Direct |
|---|---|---|---|---|
| Step | Multiplier | Add | Result | No Carry |
| 1 | 2 | 2 (as-is) | 2 | — |
| 2 | 4 | 2 + 4 = 6 | 26 | — |
| 3 | 1 | 4 + 1 = 5 | 265 | — |
| 4 | 0 | 1 + 0 = 1 | 2651 | — |
| 5 | 3 | 0 + 3 = 3 | 26513 | — |
| 6 | 4 | 3 + 4 = 7 | 265137 | — |
| 7 | 4 | 4 + 4 = 8 | 2651378 | — |
| 8 | 1 | 4 + 1 = 5 | 26513785 | — |
| 9 | 2 | 1 + 2 = 3 | 265137853 | — |
| 10 | 3 | 2 + 3 = 5 | 2651378535 | — |

| | | | |
|---|---|---|---|
| 11 | — | 3 (as-is) | 26513785353 = Final Result |

Table 6 provides a step-by-step demonstration of the ZMC 11 method using the multiplier 71935623, illustrating how the computation handles carry operations to generate the final result. Each step applies the ZMC 11 rule, where the sum a+b is calculated, and if the sum exceeds 9, a carry is generated and forwarded to the next step. For instance, in Step 3, 1+9=10 generates a carry of 1, which is forwarded to Step 2. Similarly, in Step 4, 9+3=12 generates a carry of 1, which is forwarded to Step 3. The “Current Result” column displays the progressive result at each step, incorporating the effects of carry operations. This method demonstrates the efficiency and systematic nature of the ZMC 11 computation, ultimately producing the final result 791291853791291853 as shown in Step 9.

TABLE 6

| | | | Current | Carry (if |
|---|---|---|---|---|
| Step | Multiplier | Add | Result | exists) |
| 1 | 7 | 7 (as-is) | 7 | — |
| 2 | 1 | 7 + 1 = 8 | 78 | — |
| 3 | 9 | 1 + 9 = 10 | 790 | 1 → Step 2 |
| 4 | 3 | 9 + 3 = 12 | 7912 | 1 → Step 3 |
| 5 | 5 | 3 + 5 = 8 | 79128 | — |
| 6 | 6 | 5 + 6 = 11 | 791291 | 1 → Step 5 |
| 7 | 2 | 6 + 2 = 6 | 7912918 | — |
| 8 | 3 | 2 + 3 = 3 | 79129185 | — |

| | | | |
|---|---|---|---|
| 9 | — | 3 = 3 (as-is) | 791291853 = Final Result |

Table 7 demonstrates the ZMC 6 method for multiplying the multiplicand (6) by the multiplier (87654321). The rule applied at each step is (a+b/2), where b/2 considers only the integer part and ignores the fraction (e.g., 0.5 is discarded). Additionally, if the previous digit is odd, 5 is added to the result of the rule. For example, in step 1, the first digit 88 is processed using the rule 8/2=4, resulting in a current result of 4 without any carry. In step 2, the rule 8+7/2=11 is applied, and since the result exceeds 10, a carry of 1 is added to the next step. Similarly, in step 3, the rule 7+6/2+5=15 is used because the previous digit (7) is odd, adding an extra 5. This produces another carry of 1. This process continues for each digit of the multiplier, handling carries and applying the rule systematically.

TABLE 7

| | | Rule (Add to | Current | Carry |
|---|---|---|---|---|
| Step | Multiplier | Half: a + b/2) | Result | (if exists) |
| 1 | 8 | 8/2 | 4 | — |
| 2 | 7 | 8 + 7/2 = 11 | 51 | 1 → Step 1 |
| 3 | 6 | 7 + 6/2 + 5 = 15 | 525 | 1 → Step 2 |
| 4 | 5 | 6 + 5/2 = 8 | 5258 | — |
| 5 | 4 | 5 + 4/2 + 5 = 12 | 52592 | 1 → Step 4 |
| 6 | 3 | 4 + 3/2 = 5 | 525925 | |
| 7 | 2 | 3 + 2/2 + 5 = 9 | 5259259 | — |
| 8 | 1 | 2 + 1/2 = 2 | 52592592 | — |
| 9 | — | 1 + 5 = 6 | 525925926 | — |

The final result, computed after processing all digits of the multiplier, is 525925926, showcasing the efficiency of the ZMC 6 method in performing multiplication without relying on a traditional multiplication table.

Table 8 demonstrates the step-by-step computation of the ZMC 12 method using the multiplier 65432675, applying the rule 2a+b to calculate the result at each step. Each entered number is processed by doubling the current digit and adding it to the next digit, with carry operations managed systematically. For instance, in Step 2, 2(6)+5=17 generates a carry of 1,

TABLE 8

| | | | Current | Carry |
|---|---|---|---|---|
| Step | Multiplier | 2a + b) | Result | (if exists) |
| 1 | 6 | 6 (as-is) | 6 | — |
| 2 | 5 | 2(6) + 5 = 17 | 77 | 1 → Step 1 |
| 3 | 4 | 2(5) + 4 = 14 | 784 | 1 → Step 2 |
| 4 | 3 | 2(4) + 3 = 11 | 7851 | 1 → Step 3 |
| 5 | 2 | 2(3) + 2 = 8 | 78518 | — |
| 6 | 6 | 2(2) + 6 = 10 | 785190 | 1 → Step 5 |
| 7 | 7 | 2(6) + 7 = 19 | 7851919 | 1 → Step 6 |
| 8 | 5 | 2(7) + 5 = 19 | 78519209 | 1 → Step 7 |
| 9 | — | 2(5) = 10 | 785192100 = | 1 → Step 8 |
| | | | Final result | |

which is forwarded to Step 1, updating the “Current Result” to 77. Similarly, in Step 6, 2(2)+6=10 generates a carry of 1, forwarded to Step 5. The computation continues until Step 9, where 2(5)=10 (as-is), resulting in the final result of 785192100. This example illustrates the efficiency and structured nature of the ZMC 12 method in handling multipliers while incorporating carries seamlessly.

Table 9 provides a detailed computation of the ZMC 7 method using the multiplier 65436852, applying the rule 2a+b/2. Each entered number is processed by doubling the current digit aa and adding half of the next digit bb, with carry operations managed at each step. For example, in Step 2, 2(6)+5/2=12+2=14 generates a carry of 1, which is forwarded to Step 1, updating the “Previous Result” to 4444. In Step 5, 5+2(3)+6/2=5+6+3=14 generates a carry of 1 forwarded to Step 4. The computation proceeds systematically, handling all carries, until Step 9, where 5+2(5)=15 results in the final output of 4530097775. This example demonstrates the precision and efficiency of the ZMC 7 method in performing complex multiplications while seamlessly managing carry operations.

TABLE 9

| | | Rule (Double + | Previous | Carry |
|---|---|---|---|---|
| Step | Multiplier | Half: 2a + b/2) | Result | (if exists) |
| 1 | 6 | 6/2 = 3 | 3 | — |
| 2 | 5 | 2(6) + 5/2 = 12 + 2 = 14 | 44 | 1 → Step 1 |
| 3 | 4 | 2(5) + 4/2 + 5 = 10 + 2 + 5 = 17 | 457 | 1 → Step 2 |
| 4 | 3 | 2(4) + 3/2 = 8 + 1 = 9 | 4579 | — |
| 5 | 6 | 2(3) + 6/2 + 5 = 6 + 3 + 5 = 14 | 45804 | 1 → Step 4 |
| 6 | 8 | 2(6) + 8/2 = 12 + 4 = 16 | 458056 | 1 → Step 5 |
| 7 | 2 | 2(8) + 2/2 = 16 + 1 = 17 | 4580577 | 1 → Step 6 |
| 8 | 5 | 2(2) + 5/2 = 4 + 2 = 6 | 45305776 | — |

| | | | |
|---|---|---|---|
| 9 | — | 2(5) + 5 = 15 Final Result = 453057775 | 1 → Step 8 |

Table 10 demonstrates the ZMC 10 method for multiplying a multiplicand of 10 by a multiplier (87654321). The rule applied in this method is Zeroing and Add, where the previous digit in the chain link is set to zero, and the current digit is added to compute the result. For instance, in step 1, the multiplier digit 8 is processed with the rule 8→0+8=8, resulting in a current result of 8. Similarly, in step 2, the digit 7 is processed as 7→0+7=7, updating the current result to 87. This pattern continues for each digit in the multiplier, sequentially adding the current digit to the zeroed-out previous value. In the final step, a zero is added as there are no remaining digits, completing the computation.

The Final Result of this multiplication is 876543210, showcasing the efficiency and clarity of the ZMC 10 method in handling multiplication without the need for traditional tables.

TABLE 10

| | | Rule (Zeroing and Add: | |
|---|---|---|---|
| | | Make Previous Digit 0 + | Current |
| Step | Multiplier | Current Digit) | Result |
| 1 | 8 | 8 → 0 + 8 = 8 | 8 |
| 2 | 7 | 7 → 0 + 7 = 7 | 87 |
| 3 | 6 | 6 → 0 + 6 = 6 | 876 |
| 4 | 5 | 5 → 0 + 5 = 5 | 8765 |
| 5 | 4 | 4 → 0 + 4 = 4 | 87654 |
| 6 | 3 | 3 → 0 + 3 = 3 | 876543 |
| 7 | 2 | 2 → 0 + 2 = 2 | 8765432 |
| 8 | 1 | 1 → 0 + 1 = 1 | 87654321 |
| 9 | — | 0 | Final Result = 876543210 |

Table 11 demonstrates the ZMC 5 method for multiplying a multiplicand of 5 by the multiplier 87654321, using the rule Zeroing and Add with Half. In this method, the previous digit is set to zero, and half of the current digit is added, considering only the integer part. Additionally, if the previous digit (from the prior step) is odd, 5 is added to the result. For instance, in step 1, the rule 8/2=4 is applied, producing a current result of 4. In step 2, the rule 0+7/2=3 is used, yielding a result of 43. In step 3, since the previous digit is odd, 0+6/2+5=8, updating the result to 438. This process continues for each digit, ensuring that carries are handled where needed. The final step checks whether the last digit (from step 8) is odd or even. Since the previous digit is odd, the result is 5, leading to the final output of 438271605.

TABLE 11

| Step | Multiplier | Rule Applied | Current Result |
|---|---|---|---|
| 1 | 8 | 8/2 = 4 | 4 |
| 2 | 7 | 0 + 7/2 = 3 | 43 |
| 3 | 6 | 0 + 6/2 + 5 = 8 | 438 |
| 4 | 5 | 0 + 5/2 = 2 | 4382 |
| 5 | 4 | 0 + 4/2 + 5 = 7 | 43827 |
| 6 | 3 | 0 + 3/2 = 1 | 438271 |
| 7 | 2 | 0 + 2/2 + 5 = 6 | 4382716 |
| 8 | 1 | 0 + 1/2 = 0 | 43827160 |
| 9 | — | 5 | Final Result = 438271605 |

Table 12 illustrates a step-by-step computation for the ZMC 9 method using the multiplier 8543627, based on the rule 9−a+b. At each step, the entered number is processed according to the rule, with carry operations handled systematically when applicable. For example, in Step 4, 9-3+6=12 generates a carry of 1, which is forwarded to Step 3, updating the “Previous Result” to 7689276892. Similarly, in Step 7, 9-2+7=14 produces a carry of 1, forwarded to Step 6. The calculation proceeds until the final step, where 10−7=3 results in the final output 76892643. This example highlights the structured nature of the ZMC 9 method, ensuring accuracy while effectively managing carry operations.

TABLE 12

| | Entered | | Current | Carry |
|---|---|---|---|---|
| Step | Number | Rule (9 − a + b) | Result | (if exists) |
| 1 | 8 | 8 − 1 = 7 | 7 | |
| 2 | 5 | 9 − 8 + 5 = 6 | 76 | — |
| 3 | 4 | 9 − 5 + 4 = 8 | 768 | — |
| 4 | 3 | 9 − 4 + 3 = 8 | 7688 | — |
| 5 | 6 | 9 − 3 + 6 = 12 | 76892 | 1 → Step 3 |
| 6 | 2 | 9 − 6 + 2 = 5 | 768925 | — |
| 7 | 7 | 9 − 2 + 7 = 14 | 7689264 | 1 → Step 6 |

| | | | |
|---|---|---|---|
| 8 | — | 10 − 7 = 3 | 76892643 = Final Result |

Table 13 demonstrates the ZMC 4 method for multiplying the multiplicand (4) by the multiplier (8765432), with the specific rule (a/2)−1 applied for the first step and (9−a+b/2) for subsequent steps. The process begins with the first digit of the multiplier, 88, where the rule (8/2)−1=3 is applied, resulting in a current result of 3 without any carry. In step 3, the rule 9−7+6/2+5=10 generates a carry of 1, which is added to the result of step 2, updating the total to 350. Similarly, in step 5, the rule 9−5+4/2+5=11 produces another carry of 1, added to the result of step 4, yielding 35071. Finally, in step 7, the rule 9−3+2/2+5=12 generates a carry of 1, which is added to the result of step 6, bringing the total to 3506172. The final step involves the last digit of the multiplier, 1, where the rule 10−1=9 is applied to compute the final result of 35061728.

This step-by-step application of ZMC 4 demonstrates its efficiency and precision in handling carries and intermediate results, ultimately producing an accurate multiplication result for the given inputs.

TABLE 13

| | Entered | Rule (9 − a + b/2, Add | Current | Carry |
|---|---|---|---|---|
| Step | Number | 5 if Previous Odd) | Result | (if exists) |
| 1 | 8 | (8/2) − 1 = 3 | 3 | |
| 2 | 7 | 9 − 8 + 7/2 = 4 | 34 | — |
| 3 | 6 | 9 − 7 + 6/2 + 5 = 10 | 350 | 1 → Step 2 |
| 4 | 5 | 9 − 6 + 5/2 = 6 | 3506 | — |
| 5 | 4 | 9 − 5 + 4/2 + 5 = 11 | 35071 | 1 → Step 4 |
| 6 | 3 | 9 − 4 + 3/2 = 6 | 350616 | |
| 7 | 2 | 9 − 3 + 2/2 + 5 = 12 | 3506172 | 1 → Step 6 |

| | | | |
|---|---|---|---|
| 8 | — | 10 − 1 = 9 | 35061728 = Final Result |

Table 14 illustrates the step-by-step application of the ZMC 8 method for multiplying a multiplicand of 8 by the multiplier 8754096, using the specified computational rules. In this method, the first step subtracts 2 from the first digit of the multiplier 8−2=6) to compute the initial result. For the subsequent steps, the rule 2(9−a)+b is applied, where aa is the previous digit (from the result) and bb is the current digit of the multiplier. The final step involves the rule 2(10−a) to compute the result.

In step 1, the computation starts with 8−2=6, producing the initial result of 6. In step 2, 2(9−8)+7=9 is computed, appending 9 to the result, giving 69. Step 3 uses 2(9−7)+5=9, updating the result to 699. Step 4 produces a carry of 1 after 2(9−5)+4=12, appending 2 and carrying 1 forward. The process continues systematically, with step 2(9−0)+9=27) generating a carry of 2. The final step computes 2(10−6)=8, appending 8 to produce the final result of 70032768.

This example demonstrates the efficiency and precision of the ZMC 8 method, handling intermediate results and carries seamlessly while operating in real time.

TABLE 14

| | | | Current | Carry |
|---|---|---|---|---|
| Step | Multiplier) | Computation | Result | (if exists) |
| 1 | 8 | 8 − 2 = 6 | 6 | — |
| 2 | 7 | 2(9 − 8) + 7 = 9 | 69 | — |
| 3 | 5 | 2(9 − 7) + 5 = 9 | 699 | — |
| 4 | 4 | 2(9 − 5) + 4 = 12 | 7002 | 1 → Step 3 |
| 5 | 0 | 2(9 − 4) + 0 = 8 | 70030 | 1 → Step 4 |
| 6 | 9 | 2(9 − 0) + 9 = 27 | 700327 | 2 → Step 5 |
| 7 | 6 | 2(9 − 9) + 6 = 6 | 7003276 | — |
| 8 | — | 2(10 − 6) = 8 | 70032768 | — |

Table 15 demonstrates the ZMC 3 method for multiplying a multiplicand of 3 by the multiplier 875096, using specific computational rules. In the first step, the rule (a/2)−2 is applied, where aa is the first digit of the multiplier. For subsequent steps, rule 2(9−a)+b/2 is applied, where aa is the previous digit (from the current result), and bb is the current digit of the multiplier. Additionally, if the previous digit (aa) is odd, 5 is added to the result. The final step uses rule 2(10−a).

In step 1, the computation begins with (8/2)−2=2, yielding a current result of 2. In step 2, the rule 2(9−8)+7/2=5 updates the result to 25. In step 3, 2(9−7)+5/2+5=11 results in a carry of 1, updating the result to 261. This process continues, systematically handling the multiplier digits, with intermediate results and carries where applicable. For instance, in step 6, 2(9−0)+9/2=22 produces a carry of 2, which is added to the next step. The final step computes 2(10−6)=8, appending 88 to the current result, yielding the Final Result: 26262288.

This example highlights the structured and systematic approach of ZMC 3, showcasing its ability to handle intermediate calculations, carries, and step-by-step updates efficiently, even without prior knowledge of the multiplier's size or digit values.

TABLE 15

| | | | Current | Carry |
|---|---|---|---|---|
| Step | Multiplier | Computation | Result | (if exists) |
| 1 | 8 | (8/2) − 2 = 2 | 2 | — |
| 2 | 7 | 2(9 − 8) + 7/2 = 5 | 25 | — |
| 3 | 5 | 2(9 − 7) + 5/2 + 5 = 11 | 261 | 1 → Step 2 |
| 4 | 4 | 2(9 − 5) + 4/2 + 5 = 15 | 2625 | 1 → Step 3 |
| 5 | 0 | 2(9 − 4) + 0/2 = 10 | 26260 | 1 → Step 4 |
| 6 | 9 | 2(9 − 0) + 9/2 = 22 | 262622 | 2 → Step 5 |
| 7 | 6 | 2(9 − 9) + 6/2 + 5 = 8 | 2626228 | — |

| | | | |
|---|---|---|---|
| 8 | — | 2(10 − 6) = 8 | 26262288 = Final Result |

The Direct No Carry ZMC methods provide a seamless and innovative approach to multiplication, eliminating the complexities associated with carry operations. By ensuring that sums within each chain link remain below 10, these methods enable fast, accurate, and intuitive calculations. For ZMC 8 to ZMC 11, all multipliers are supported, maintaining consistency and simplicity across any input. Meanwhile, for ZMC 3 to ZMC 7, the methods are optimized for even multipliers, as odd multipliers require adding 5, which often results in sums exceeding 9, introducing carries and disrupting the no-carry advantage.

This innovative design focuses on straightforward addition and logical progression, making multiplication accessible and efficient. The methods eliminate the need for memorizing multiplication tables and offer a practical alternative for users at any level. With these principles and applications clearly illustrated, this detailed description concludes, showcasing the practical benefits and inventive steps underpinning the ZMC methods.

1: Zargelin Mathematical Chain (ZMC) Method
A method for performing multiplication using the Zargelin Mathematical Chain (ZMC), comprising:
1. Dynamic Chain Link Formation:
Forming a sequence of chain links either in real time or after the entire multiplier is entered, corresponding to the digits of the multiplier, where:
The first (leftmost) and last (rightmost) chain links each include only one digit.
Any middle chain link includes two digits.
The number of chain links equals the number of multiplier digits plus one.
2. Sequential Processing of Digits:
The entire process can be completed in real time, with each chain link processed as it is formed, starting from the leftmost chain link and proceeding to the right.
Alternatively, chain links can be formed after the entire multiplier is entered and then processed sequentially from left to right.
3. Carry Management:
Retaining the ones digit in the result of each chain link while propagating the tens digit to the preceding chain link for adjustment.
4. Sub-ZMC Multiplication Rules:
Selecting specific multiplication rules based on the multiplicand using predefined sub-ZMC methods. All rules are applied consistently within each chain link, including:
ZMC 11: Add the left digit to the right digit.
ZMC 6 E: Add the left digit to half of the right digit.
ZMC 6 O: Add 5 to the left digit, then add it to half of the right digit.
ZMC 12: Double the left digit and add it to the right digit.
ZMC 7 E: Double the left digit and add it to half of the right digit.
ZMC 7 O: Double the left digit, add 5, then add it to half of the right digit.
ZMC 10: Zero the left digit and add it to the right digit.
ZMC 5 E: Zero the left digit and add it to half of the right digit.
ZMC 5 O: Zero the left digit, add 5, then add it to half of the right digit.
ZMC 9: Subtract 1 from the left digit in the first chain link, complement each left digit using the 9-complement, and add it to the right digit. For the last chain link, use the 10-complement of the right digit.
ZMC 4 E: Subtract 1 from half of the left digit in the first chain link, complement each left digit using the 9-complement, and add it to half of the right digit. For the last chain link, use the 10-complement.
ZMC 4 O: Subtract 1 from half of the left digit in the first chain link, complement each left digit using the 9-complement, add 5, and add it to half of the right digit. For the last chain link, use the 10-complement.
ZMC 8: Subtract 2 from the left digit in the first chain link, use twice the 9-complement, and add it to the right digit. For the last chain link, use twice the 10-complement.
ZMC 3 E: Subtract 2 from half of the left digit in the first chain link, use twice the 9-complement, and add it to half of the right digit. For the last chain link, use twice the 10-complement.
ZMC 3 O: Subtract 2 from half of the left digit in the first chain link, use twice the 9-complement, add 5, and add it to half of the right digit. For the last chain link, use twice the 10-complement.
ZMC 2: If the right digit is greater than 4, add 1 to double the left digit; otherwise, the result is twice the left digit.
5. Temporary Result Production:
Writing the temporary result by appending the output of each chain link directly to the preceding result, with adjustments for carries.
6. Final Result Production:
Appending the output of the last chain link to the temporary result to produce the final result.
7. Output and Display:
Providing a visual representation of the chain links, results, and carry operations, ensuring clarity and accuracy.
Drawing chain links using:
Virtual Materials: Such as digital illustrations on screens.
Physical Materials: Such as plastic or metal for tangible educational tools.
Customizable Materials: Using colors or transparent elements to clarify calculations visually.

2: ZMC Educational Calculator
An educational calculator configured to implement the method in claim 1, comprising:
1. User-Friendly Interface for Sub-Calculators:
Allowing users to select a sub-ZMC calculator, such as ZMC 11, with a clear display of the selected rule and interactive instructions.
2. Dynamic Chain Link Visualization:
Automatically generating chain links in real time based on user input and the selected ZMC method.
Displaying chain links with their corresponding operations and results annotated dynamically.
3. Educational Features:
Supporting various learning modes, including:
Goodbye Multiplication Table: Teaching multiplication without memorization.
Direct No Carry: Restricting inputs to avoid carry operations.
Indirect No Carry: Allowing user-defined input restrictions.
Carry+: Teaching users how to handle carries generated by other carries.
Detailed Mode: Providing comprehensive explanations of intermediate results.
4. Multi-Language Support:
Allowing users to select the desired language from an internal menu.
5. Interactive Input and Display Fields:
Enabling users to input digits according to the sub-ZMC rules.
Displaying the multiplier below the input field and showing temporary results dynamically.
6. Output and Display:
Presenting the final result with a detailed breakdown of steps and calculations.
Using distinct colors for chain links, results, and carry indicators to enhance visual clarity.
Allowing users to save, review, or clear results for continuous learning.

3: Interactive Circular Diagram for Teaching ZMC Multiplication Rules
A dynamic circular diagram designed for teaching and memorizing Zargelin Mathematical Chain (ZMC) multiplication rules, segmented by multiplicands (e.g., ×3, ×6, ×7) with operations differentiated for even and odd digits when the multiplicand is less than 8, and unified operations for ZMC 8 through ZMC 12 where the whole number is utilized instead of its half. The diagram incorporates customizable features, including adjustable methods, materials, and colors, enabling tailored instruction and user engagement. It further supports interactive functionality, such as selectively displaying desired rules for focused learning, enhancing adaptability and effectiveness in teaching mental arithmetic strategies.
Dependent claims for claim 1: Zargelin Mathematical Chain (ZMC) Method
1. Dependent claim: The method according to claim 1, wherein chain links are dynamically formed in real time or after the entire multiplier is entered, corresponding to its digits, and displayed with clear visual representation to clarify the calculations.
2. Dependent claim: The method according to claim 1, wherein chain links are dynamically formed in real time or after the entire multiplier is entered, and can be connected together as a continuous sequence or displayed as separated links, with clear visual representation provided to clarify the calculations.
3. Dependent claim: The method according to claim 1, wherein chain links are processed sequentially, starting from the leftmost link, with step-by-step instructions provided to clarify the calculations.
4. Dependent claim: The method according to claim 1, wherein the ones digit in the result of each chain link is retained, and the tens digit is carried over to the result of the preceding link to make necessary adjustments for both the previous result and the temporary result.
5. Dependent claim: The method according to claim 1, wherein sub-ZMC rules are applied based on the multiplicand type, such as:
Adding the left and right digits.
Doubling the left digit and halving the right digit according to the specified rule.
Using the 9-complement and 10-complement for rules such as ZMC 9, 8, 4, and 3.
Zeroing the left digit for ZMC 10 and 5.
6. Dependent claim: The method according to claim 1, wherein intermediate results are clearly displayed, using arrows and indicators to show the carry propagation between links.
7. Dependent claim: The method according to claim 1, wherein chain links are drawn using:
Virtual materials: Such as digital illustrations.
Physical materials: Such as plastic or metal.
Customizable materials: Using colors or transparent elements to clarify calculations visually.
8. Dependent claim: The method according to claim 1, wherein visual teaching aids are included to illustrate how to handle indirect carry propagation resulting from direct carry operations, using the “Carry+” feature.
Dependent claims for claim 2: ZMC Educational Calculator
1. Dependent claim: The calculator according to claim 2, wherein its interface allows users to select the appropriate ZMC method for the multiplicand, with interactive options to perform calculations directly.
2. Dependent claim: The calculator according to claim 2, wherein chain links are automatically generated and displayed dynamically, with options for the user to modify operations within the links.
3. Dependent claim: The calculator according to claim 2, wherein chain links are dynamically generated in real time or after the entire multiplier is entered, and can be displayed as either connected links forming a continuous sequence or as separated individual links, with clear visual representation provided to enhance user understanding and clarify the calculations.
4. Dependent claim: The calculator according to claim 2, wherein the “Carry+” feature is included to teach users how to handle carry propagation resulting from addition within the chain links.
5. Dependent claim: The calculator according to claim 2, wherein different colors are assigned to each chain link and its elements, including the indicator, result, and carry, to clarify the mathematical relationships.
6. Dependent claim: The calculator according to claim 2, wherein it supports multiple educational modes, such as:
“Goodbye Multiplication Table”: Teaching multiplication without memorization.
“Direct No Carry”: Restricting inputs to avoid carry propagation.
“Carry+ Mode”: Offers a detailed breakdown of carry operations, including their origin, propagation, and integration into intermediate and final results.
“Indirect No Carry Mode”: Utilizes an alternative approach to ensure no carry operations occur, focusing on keeping the chain link results less than 10.
“Detailed Mode”: Providing a comprehensive explanation of intermediate results and steps.
7. Dependent claim: The calculator according to claim 2, wherein the final result is presented with detailed steps and calculations, with options to save or review the results later.
8. Dependent claim: The calculator according to claim 2, wherein ZMC rules are categorized in a clock-inspired design, distinguishing between even and odd multiplicands for easier understanding.

4: Universal claim for All Three claims and Their Related claims:
The Zargelin Mathematical Chain (ZMC) Method, ZMC Educational Calculator, and Interactive Circular Diagram, along with their associated dependent claims, collectively provide a comprehensive system for facilitating all ZMC multiplication methods, whether performed in written form or mentally. These tools and methods are designed to simplify complex calculations, enhance learning through interactive and visual aids, and improve accuracy and efficiency in performing ZMC operations. By incorporating customizable features, adaptable materials, and educational modes, they support a wide range of user needs, enabling seamless implementation of ZMC methods across various contexts and applications.
